(19) United States
(12) Patent Application Publication
(10) Pub. No.: US 2024/0056386 A1
(43) Pub. Date: Feb. 15, 2024

(54) Hardware-Assisted Scheme for Macro-Segment Based Distributed Service Insertion in Multi-Site Data Center Switches

(71) Applicant: Cisco Technology, Inc., San Jose, CA (US)

(72) Inventors: Murukanandam Panchalingam, San Jose, CA (US); Rajagopalan Janakiraman, San Jose, CA (US); Muralidhar Annabatula, San Jose, CA (US); Junyun Li, San Jose, CA (US); Hari Hara Prasad Muthulingam, San Jose, CA (US)

(21) Appl. No.: 17/819,260

(22) Filed: Aug. 11, 2022

(51) Int. Cl. H04L 45/302; H04L 45/745

(52) U.S. Cl. CPC H04L 45/306; H04L 45/74591

(57) ABSTRACT

An embodiment of the present disclosure is directed a set of data centers and associated controls in which the data centers include network fabric comprises network routing devices configured to route bi-directional traffic symmetrically through insertable service, e.g., via the associated inter-site and intra-site controls, for a given set of policies or contracts using an ASIC or circuit-assisted arithmetic logic, enforcing such policies at the local network devices, to deterministically select the insertable services.

### TECHNICAL FIELD

Embodiments of the present invention relate to networking equipment, in particular, hardware and software architecture and components for networking equipment for use in data centers and multi-site enterprise networks.

### BACKGROUND

There are business needs to deploy independent yet interconnected data center fabrics, for example, for application fault domain isolation, separate change domains, disaster avoidance, and disaster recovery. In such applications, multi-site software-defined networks, such as application-centric infrastructure (ACI), may be configured with an inter-site controller or orchestrator that may operate in conjunction with individual intra-site software-network controllers to manage end-to-end policies.

The inter-site controller or orchestrator and intra-site controller may invoke any one of L4-L7 service insertions such as deep packet inspection (DPI), load balancing (LB), intrusion prevention system (IPS), malware protection, or firewall operations for inter-site traffic between such data centers or sites. A common type of inter-site traffic is the inter-site East-West Data Center traffic that is routed between data centers located on the West Coast US and the East Coast US. Service insertion generally refers to the adding of networking services, such as DPI, LB, firewalls, and IPS, among other services described herein, into the forwarding path of traffic. Service insertion can be performed in a chain in which the inserted services are linked in a prescribed manner, such as proceeding through a firewall, then an IPS, and finally malware protection before forwarding to the end-user.

With application-centric infrastructure (ACI), macro segmentation, and inter-site data center control, groups of host/endpoints may be defined to share similar policy characteristics (e.g., via security, performance, visibility policy or contract) within virtual machines, containers, or physical servers. These groups of host/endpoints may be referred to as EndPoint Groups (EPG).

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 shows an example network comprising a set of independent yet interconnected network sites or infrastructure having network devices configured with a hardware-assisted operation for macro-segment-based distributed service insertion in accordance with an illustrative embodiment.

FIGS. 2A, 2B, and 2C each shows an example method of operation for a hardware-assisted operation for macro-segment-based distributed service insertion in multi-site data center network devices (e.g., switches) in accordance with an illustrative embodiment in accordance with an illustrative embodiment.

FIG. 2D shows an example method of operation for a site controller or multi-controller to configure hardware-assisted operation at network devices for different network sites or infrastructure, e.g., for macro-segment-based distributed service insertion in accordance with an illustrative embodiment.

FIG. 3A shows multiple multi-tier applications each employing decentralized or split computing resources deployed at two or more data centers or remote sites.

FIG. 3B shows a network configured with a single any-to-any contract for one or more multiple multi-tier applications each employing decentralized or split computing resources deployed at two or more data centers or remote sites.

FIG. 3C shows an example configuration of local network devices, e.g., the ASIC or circuit-assisted operator logic of the network device (in combination with the inter-site controller and intra-site controller (e.g., multi-site or site controller) to provide symmetric bi-directional services for the network of FIG. 3B, in accordance with an illustrative embodiment.

FIG. 3D shows an example operation of the ASIC or logic-assisted circuit of the first and second data centers to provide symmetric bi-directional services for the network in accordance with an illustrative embodiment.

FIG. 4 shows the ASIC or logic-assisted operation executed in an ASIC pipeline in accordance with an illustrative embodiment.

FIG. 5 shows another example of operation of the ASIC or logic-assisted operation for multi-site disaster recovery (DR) operation in accordance with an illustrative embodiment.

### DESCRIPTION OF THE EXAMPLE EMBODIMENTS

Overview

In an aspect, an embodiment of the present disclosure is directed a set of data centers and associated controls in which the data centers include network fabric comprising network routing devices (e.g., switches, routers) configured to route bi-directional traffic symmetrically through insertable service, e.g., via the associated inter-site and intra-site controls, for a given set of policies or contracts using an ASIC or circuit-assisted arithmetic logic, enforcing such policies at the local network devices, to deterministically select the insertable services.

In some embodiments, a network device (e.g., switch of a first network site or infrastructure) comprising a high-speed memory (e.g., TCAM); and a logic circuitry (e.g., ASIC, NPU, or other circuitries) operatively coupled to the high-speed memory, the logic circuitry being configured, via a pipeline operation comprising arithmetic or bitwise operator, to route bi-directional traffic symmetrically through inserted services among two or more network sites or infrastructure (e.g., data center), including a first network site or infrastructure and a second network site or infrastructure by: receiving, via the logic circuitry, a packet of the bi-directional traffic for an application executing between computing resources located at the first network site or infrastructure and the second network site or infrastructure; determining, via the arithmetic or bitwise operator, an output value derived from a routing data located within the packet (e.g., source address identifier and destination address identifier, e.g., IP address or MAC address); and routing the packet to at least one of a set of one or more insertable network services in accordance with a policy or contract based at least in part on the output value of the arithmetic or bitwise operator.

In some embodiments, the packet is received at a second network device of the second network site or infrastructure; the second network device is configured to (i) receive the packet via logic circuitries of the second network device, (ii) determine via an arithmetic or bitwise operator of the second network device an output value derived from the routing data located within the packet, and (iii) route the packet to at least one of a set of one or more insertable network services of the second network site or infrastructure in accordance with the policy or contract based at least in part on the output value of the arithmetic or bitwise operator of the second network device.

In some embodiments, the routing of the packet to at least one of the set of one or more insertable network services in accordance with the policy or contract employs (i) the output value of the arithmetic or bitwise operator and (ii) a flag or identifier associated with the destination address being a local network device of a network associated with the network device.

In some embodiments, the arithmetic or bitwise operator comprises an arithmetic comparator.

In some embodiments, the arithmetic or bitwise operator comprises an XOR bitwise comparator.

In some embodiments, the set of one or more insertable network services includes at least one of a deep packet inspection (DPI) service, a load balancing (LB) service, an intrusion prevention system (IPS) service, a malware protection service, and a firewall inspection service.

In some embodiments, the policy or contract includes at least one of a security policy, a performance policy, a quality-of-service (QOS) policy, a disaster recovery policy, and a visibility policy.

In some embodiments, the high-speed memory maintains a logic table that selects, via a single lookup action of high-speed memory, a network action (e.g., by a data plane of the network device) to route the packet to the set of one or more insertable network services in accordance with the policy or contract or to bypass the network action.

In some embodiments, the high-speed memory comprises tertiary content addressable memory (TCAM).

In some embodiments, the logic table includes a first rule to select the network action to route the packet to the set of one or more insertable network services in accordance with the policy or contract based on a first value (e.g., FALSE) for the arithmetic or bitwise operator and a masked value (e.g., don't care) for a flag or identifier associated with the destination address being a local network device of a network associated with the network device.

In some embodiments, the logic table includes a second rule to select the network action to route the packet to the set of one or more insertable network services in accordance with the policy or contract based on a masked value (e.g., don't care) for the arithmetic or bitwise operator and a second value (e.g., TRUE) for a flag or identifier associated with the destination address being a local network device of a network associated with the network device.

In some embodiments, the logic table includes a third rule to bypass the network action to route the packet to the set of one or more insertable network services in accordance with the policy or contract based on a second value (e.g., TRUE) for the arithmetic or bitwise operator and a first value (e.g., FALSE) for a flag or identifier associated with the destination address being a local network device of a network associated with the network device.

In some embodiments, the policy or contract is defined at an inter-site controller or an intra-site controller, the policy or contract being provided from the inter-site controller or the intra-site controller to configure the logic table.

In some embodiments, the network device further includes a processor; and a memory having instructions stored thereon, wherein execution of the instructions by the processor causes the processor to (i) receive the policy or contract (e.g., from the inter-site controller or the intra-site controller) and (ii) store routing action of the policy or contract to the high-speed memory.

In some embodiments, the packet is a multicast packet and is received at the second network device of the second network site or infrastructure and a third network device of the second network site or infrastructure.

In some embodiments, the packet is a multicast packet and is received at the second network device of the second network site or infrastructure and a third network device of a third network site or infrastructure.

In another aspect, a system (e.g., inter-site controller or the intra-site controller) is disclosed comprising a processor; and a memory having instructions stored thereon, wherein execution of the instructions by the processor causes the processor to: receive (or determine) a policy or contract for a set of one or more insertable network services to execute between two or more network sites or infrastructure (e.g., data center), including a first network site or infrastructure and a second network site or infrastructure; transmit the policy or contract to one or more first network devices of the first network site or infrastructure, including a first network device, and one or more second network devices of the second network site or infrastructure, including a second network device, wherein the first network device and the second network device are configured to symmetrically route bi-directional traffic among each other, wherein the first network device includes a high-speed memory (e.g., TCAM) and a logic circuitry (e.g., ASIC, NPU, or other circuitries) operatively coupled to the high-speed memory, the logic circuitry being configured, via a pipeline operation comprising arithmetic or bitwise operator, to symmetrically route bi-directional traffic with the second network device.

In some embodiments, the bi-directional traffic is received at a second network device of the second network site or infrastructure; the second network device is configured to (i) receive a packet of the bi-directional traffic via logic circuitries of the second network device, (ii) determine via an arithmetic or bitwise operator of the second network device an output value derived from the routing data located within the packet, and (iii) route the packet to at least one of a set of one or more insertable network services of the second network site or infrastructure in accordance with the policy or contract based at least in part on the output value of the arithmetic or bitwise operator of the second network device.

In some embodiments, the first network device is configured to route a packet to at least one of a set of one or more insertable network services in accordance with the policy or contract using (i) an output value determined from the arithmetic or bitwise operator and (ii) a flag or identifier associated with the destination address being a local network device of a network associated with the first network device.

In some embodiments, the arithmetic or bitwise operator comprises an arithmetic comparator or an XOR bitwise comparator.

### Example System

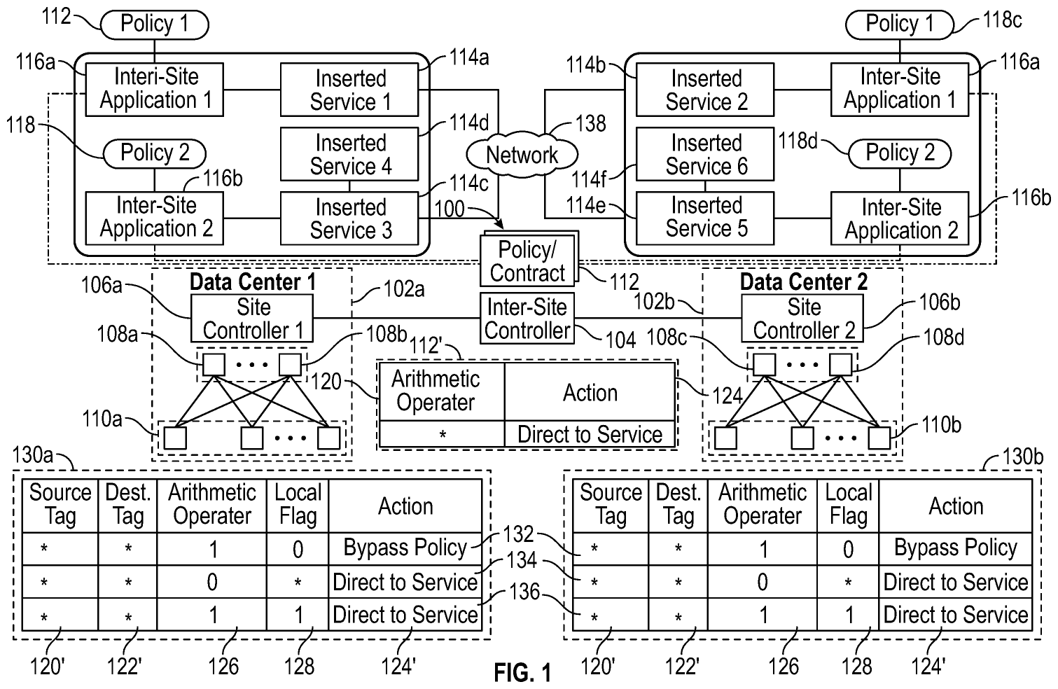

FIG. 1 shows an example network 100 comprising a set of independent yet interconnected network site or infrastructure 102 (shown as “Data Center 1” 102a and “Data Center 2” 102b) and associated controls comprising an inter-site controller 104 and intra-site controllers 106 (shown as “Site Controller 1” 106a, “Site Controller 2” 106b). Each network site or infrastructure 102 may include a fabric comprising a set of network devices 108 (shown as 108a, 108b at site 102a; 108c, 108d at site 102b) connected to a set of computing resources 110 (shown as 110a and 110b for each respective sites 102a, 102b). The inter-site controller 104 and/or intra-site controllers 106 are configured to maintain and enforce a set of policies or contracts 112 for a set of software-defined-network (SDN) insertable services 114 (shown as “Inserted Service 1” 114a to “Inserted Service 6” 114f) associated with a set of software-defined-network (SDN) applications 116 (shown as “Inter-site Application 1” 116a and “Inter-site Application 2” 116b).

In the example shown in FIG. 1, the two example policies/contracts are enforced for two set of inter-site applications (116a, 116b) between sites 102a and 102b. The first policy 112 may define or call for a set of inserted services 114a and 114b for the inter-site application “1” 116a between the two sites 102a, 102b. The second policy 118 may define or call for a second set of inserted services (shown as chained services 114c, 114d, and 114e, 114f) for the inter-site application “2” 116b between the two sites 102a, 102b. The policies 112, 118 may be defined, generated, or received at the inter-site controller 104 or intra-site controller 106s and provided to the local network devices 108 (e.g., 108a, 108b, 108c, 108d). While in the example of FIG. 1, the inter-site controller 104 and the intra-site controller 106 are shown as distinct networking appliances, it should be appreciated that in other embodiments, the inter-site controller 104 may be implemented as a network appliance that can serve as both an intra-site controller 106 for a given site as well as for inter-site control, or that the intra-site controller 106 (e.g., 106a, 106b) for a given site may also serve as an inter-site controller for inter-site coordination with respect to policies/contracts.

The terms “policy” and “contract” (e.g., 112) are used interchangeably herein and refer to a collection of network control rules that includes the controls for a set of one or more service insertions (or a set thereof comprising service chaining for multiple linked service insertions) in which network services are insertable in a software-defined network operation (e.g., software-defined WAN or LAN) that can provide such network services as a central location to a set of computing or network resources. The policy or contract can be employed for any type of application-centric infrastructure (ACI), macro segmentation, and multi-site data center control to share similar any type of policy characteristics (e.g., via a security, performance, visibility policy or contract). In some embodiments, the policy can be arbitrarily defined or can be an aggregate of multiple policies (e.g., security and inspection, etc.). The software-defined network operation beneficially aggregates the network service to a single location or hub that would otherwise have to be individually deployed for all applicable network appliances or computing resources, thus improving the execution and maintenance of such services.

The term “insertable services” (also referred to as “inserted services”) (e.g., 114) refers to L4, L5, L6, or L7 insertable services such deep packet inspection (DPI), load balancing (LB), intrusion prevention system (IPS), intrusion detection system (IDS), malware protection, firewall operations such as web application firewall (WAF), WAN optimization, WAN accelerators, encryption and decryption, secure socket layer (SSL) offload, among other. In some embodiments, the insertable services (e.g., 114) may be deployed additionally using specialized controllers/network appliances, e.g., via an application policy infrastructure controller (APIC) (not shown) and/or an application delivery controller (APC) (not shown).

In the example shown in FIG. 1, the policy or contract 112 includes a service action 124 (shown as “Action” 124) that are invokable based on an arithmetic operator or bitwise operator (shown as “Arithmetic Operator” 120) that are performed by an ASIC or logic assisted operator that is implemented in the data plane of network devices executing in a set of data centers or remote sites. The arithmetic operator or bitwise operator may also define corresponding conditions to bypass the rules to route the packet or traffic to a given service action 124. The arithmetic operator or bitwise operator may be performed on a tag value (also referred to as a parameter value or a classification identifier) derived from information within the packet, e.g., the source MAC address, the destination MAC address, the source IP address, the destination IP address, or other information in the packet header. In some embodiments, the tag value or classification identifier may be defined at the inter-site controller 104 or the intra-site controllers 106.

The arithmetic operator or bitwise operator ensures that the routing to the inserted network service(s) is deterministically selected and consistently applied in an inter-network-wide manner by local hardware to provide symmetrical bi-directional traffic through inserted network services for a given policy or contract. Examples of arithmetic logic (e.g., 126) include arithmetic comparators (such as less than or greater than) or bitwise operators such as exclusive-OR (XOR), e.g., for a set of predefined digits. In some embodiments, the operation is performed on the entire tag value (parameter value or classification identifier). In other embodiments, the operation is performed on a portion of the tag value (parameter value or classification identifier), e.g., on a pre-defined length of the MSB or the LSB of the such values.

In other embodiments, the operator may be based on a hash operator.

In some embodiments, the arithmetic operator or bitwise operator may also operate in conjunction with a second condition, e.g., if the received packet is received a network node and the destination is local to that node, i.e., within the same intra-site or data center. That is, a host connected to a network node is identified as determination-is-local when the network node (e.g., ToR/switch) directly receives packets from the host. The arithmetic operator or bitwise operator and second condition may be invoked once which may be tracked by an applied-once flag or identifier provided in the packet.

In the example shown in FIG. 1, the inter-site controller 104 and/or intra-site controllers 106 may define a set of symmetric bi-directional traffic policies 130 (shown as 130a, 130b) for a set of three scenarios: a first scenario 132 to bypass the service policy in which the arithmetic operator has a value of “1” and the local flag value has a value of “0”, and a second and third scenario 134, 136 to direct the traffic to an associated network service in which either the “arithmetic operator” has a value of “0” or the destination-is-local flag has a value of “1.” Other values may be used for the arithmetic operator, and the destination-is-local flag may be employed.

The symmetric bi-directional traffic is routed through an external network 138 such as an internet service provider (ISP) network, telecom carrier, network provider, or a combination thereof.

Example Methods of Operation to Macro-Segment using Hardware Assisted Operation.

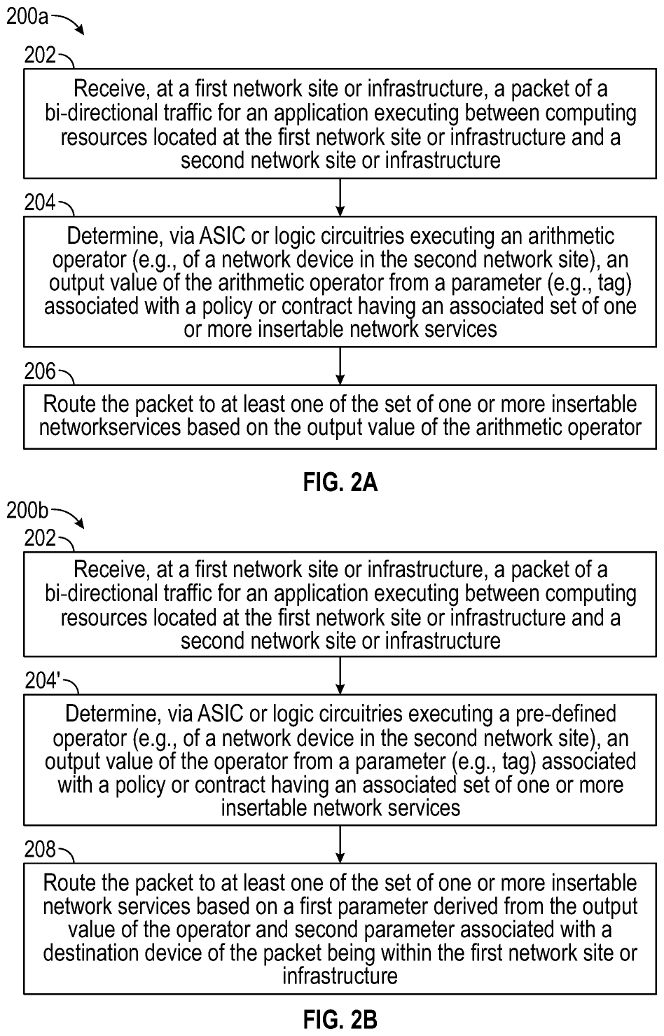

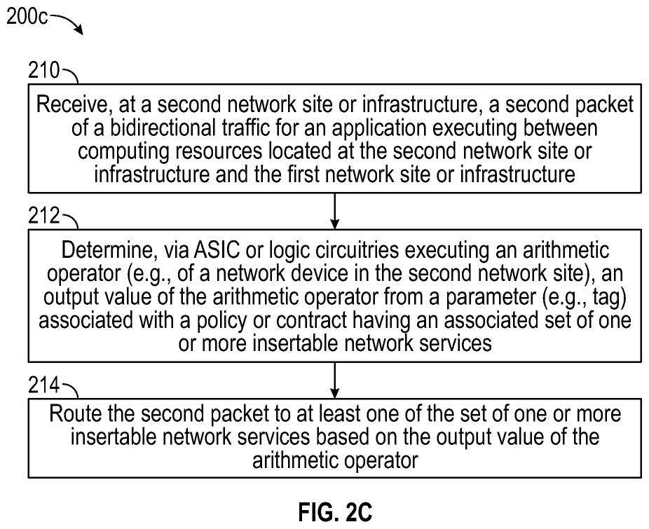

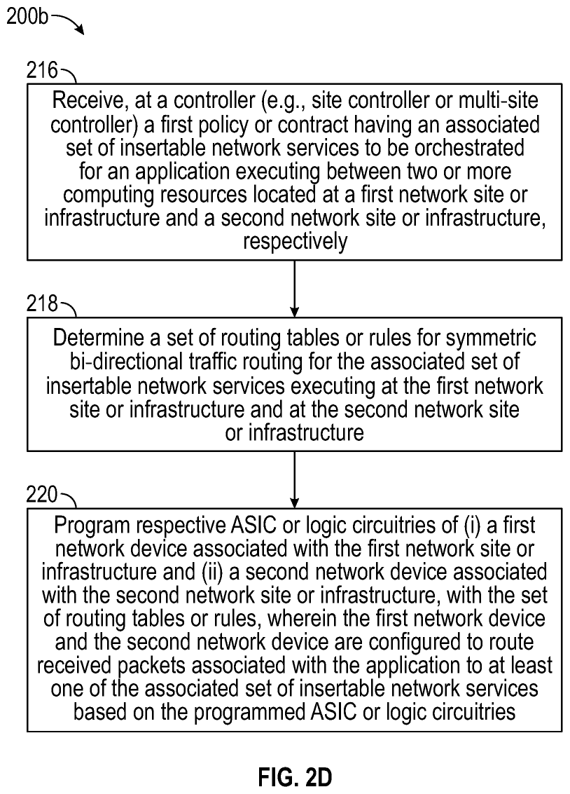

FIGS. 2A, 2B, and 2C each shows an example method 200 (shown as 200a, 200b, and 200c, respectively) of operation for a hardware-assisted operation for macro-segment-based distributed service insertion in multi-site data center network devices (e.g., switches) in accordance with an illustrative embodiment.

As used herein, the term “hardware-assisted” refers to data-plane resources or logic circuitries that are performed in a processing pipeline or a hardware-accelerated circuit or memory, e.g., via tertiary CAMs (TCAMs) that are employed for packet routing in switch gear equipment or appliance. In some embodiments, the hardware-assisted operation is performed on a packet basis, i.e., at 100 Gbits/second or greater, to correspond to packet routing speed. In some embodiments, the operation is performed for a per-flow basis. In some embodiments, the operation is performed on a multi-cast packet.

In an aspect, Method 200a is configured to route bi-directional traffic symmetrically through insertable services between two network sites or infrastructure (e.g., data centers) in accordance with an illustrative embodiment.

Method 200a includes receiving (202), at a first network site or infrastructure, a packet of bi-directional traffic for an application (e.g., 116) executing between computing resources (e.g., 110) (e.g., hosts) located at the first network site or infrastructure (e.g., 102) and a second network site or infrastructure (e.g., 102).

Method 200a then includes determining (204), via ASIC or logic circuitries executing an arithmetic operator (e.g., of a network device in the first network site), an output value (e.g., 126) of the arithmetic operator from a parameter (e.g., tag) (e.g., 120, 122) associated with a policy or contract (e.g., 112) having an associated set of one or more insertable network services (e.g., 114).

Method 200a then includes routing (206) the packet to at least one of the sets of one or more insertable network services (e.g., 114) based on the output value (e.g., 126) of the arithmetic operator.

In another aspect, Method 200b is configured to route bi-directional traffic symmetrically through insertable services between two or more network sites or infrastructures (e.g., data centers) in accordance with another illustrative embodiment.

Method 200b includes receiving (202), at a first network site or infrastructure, a packet of bi-directional traffic for an application (e.g., 116) executing between computing resources (e.g., 110) located at the first network site or infrastructure (e.g., 102) and a second network site or infrastructure (e.g., 102).

Method 200b then includes determining (204′), via ASIC or logic circuitries executing an arithmetic operator (e.g., of a network device in the first network site), an output value (e.g., 126) of the arithmetic operator from a parameter (e.g., tag) (e.g., 120, 122) associated with a policy or contract (e.g., 112) having an associated set of one or more insertable network services (e.g., 114). The ASIC or logic circuitries may additionally determine a packet destination lookup to determine if the destination device is located within the first network site or infrastructure.

Method 200b then includes routing (208) the packet to at least one of the sets of one or more insertable network services based on (i) a first parameter derived from the output value of the operator and (ii) a second parameter associated with a destination device of the packet being within the first network site or infrastructure. In some embodiments, the first parameters and second parameters are based on a tag (e.g., policy or contract tag) assigned to the application (e.g., 116) executing between the computer resources (e.g., 110) located on the different network sites or infrastructures (e.g., 102). The operator may be an arithmetic operator, e.g., an arithmetic comparator, an XOR operator, or other pipeline-able hardware or logic circuit described herein.

It should be appreciated that Methods 200a and 200b may be performed on a second or third network site or infrastructure, and etc., for a second or third set of insertable network services, respectively, executing thereat for the given application (e.g., 116) to provide the symmetric bi-directional traffic routing through corresponding insertable services between two or more network sites or infrastructures. FIG. 2C shows a method 200c that may be performed in combination with the methods 200a or 200b of FIGS. 2A and 2B to provide the symmetric bi-directional traffic routing operation. Method 200c includes receiving (210), at a second network site or infrastructure, a second packet of the bi-directional traffic for the application (e.g., 116) executing between computing resources (e.g., 110) located at the first network site or infrastructure (e.g., 102) and the second network site or infrastructure (e.g., 102).

Method 200b then includes determining (212), via ASIC or logic circuitries executing an arithmetic operator (e.g., of a network device in the second network site), an output value (e.g., 126) of the arithmetic operator from a parameter (e.g., tag) (e.g., 120, 122) associated with the policy or contract (e.g., 112) having an associated set of one or more insertable network services (e.g., 114).

Method 200c then includes routing (206) the packet to at least one of the set of one or more insertable network services (e.g., 114) of the second network site based on the output value (e.g., 126) of the arithmetic operator.

Example Method of Operation for Inter-Site or Intra-Site Controller to Configure Bi-Directional Symmetric Traffic Between Inserted Services

FIG. 2D shows an example method 200d of operation for a site controller or multi-controller to configure hardware-assisted operation at network devices for different network sites or infrastructure, e.g., for macro-segment-based distributed service insertion in accordance with an illustrative embodiment.

Method 200d includes receiving (216) (or generating), at a controller (e.g., an intra-site controller (e.g., 106) or inter-site controller (e.g., 104)), a first policy or contract (e.g., 112) having an associated set of insertable network services (e.g., 114) to be orchestrated for an application (e.g., 116) executing between two or more computing resources (e.g., 110) located at a first network site or infrastructure (e.g., 102) and a second network site or infrastructure (e.g., 102), respectively

Method 200d includes determining (218) a set of routing tables or rules (e.g., 130) for symmetric bi-directional traffic routing for the associated set of insertable network services (e.g., 114) executing at the first network site or infrastructure (e.g., 102) and at the second network site or infrastructure (e.g., 102).

Method 200d includes programming (220) respective ASIC or logic circuitries of (i) a first network device (e.g., 108) associated with the first network site or infrastructure (e.g., 102) and (ii) a second network device (e.g., 108) associated with the second network site or infrastructure (e.g., 102), with the set of routing tables or rules (e.g., 130) in which the first and second network devices (e.g., 108) are configured to route received packets associated with the application (e.g., 116) to at least one of the associated set of insertable network services (e.g., 114) based on the programmed ASIC or logic circuitries.

In some embodiments, the programmed ASIC or logic circuitries can execute the methods (e.g., 200a, 200b, and/or 200c) as described in relation to FIGS. 2A, 2B, and 2C.

In some embodiments, the programmed ASIC or logic circuitries can execute a bitwise operator or an arithmetic operator in a hardware-assisted pipeline or ASIC pipeline to route the symmetric bi-directional traffic through the desired inserted network services.

Example Multi-Site Service Insertion Architecture with ACI

With application-centric infrastructure (ACI) technology, and the like, a group of computing resources, e.g., EndPoint Groups (EPG), can be created as a foundational construct on which policies (e.g., contracts), e.g., for security, performance, quality-of-service (QoS) metrics or tags, disaster recovery, among others described herein can be deployed. To this end, an EPG can include and represent (i.e., by an EPG number) a group of host/endpoints behind virtual machines, containers, or physical servers that each share similar policy characteristics (e.g., security characteristics).

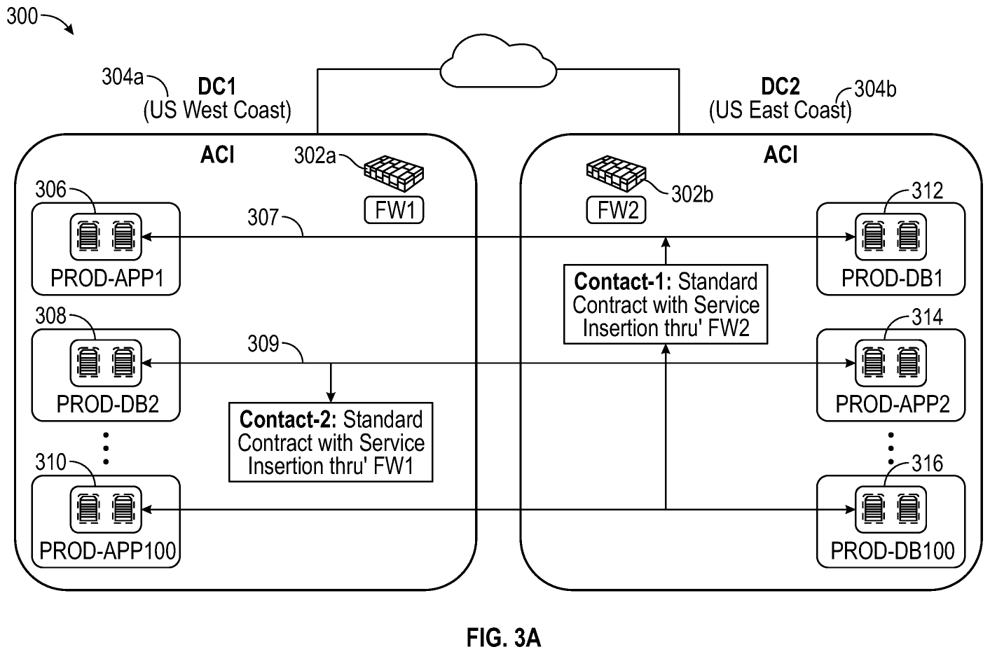

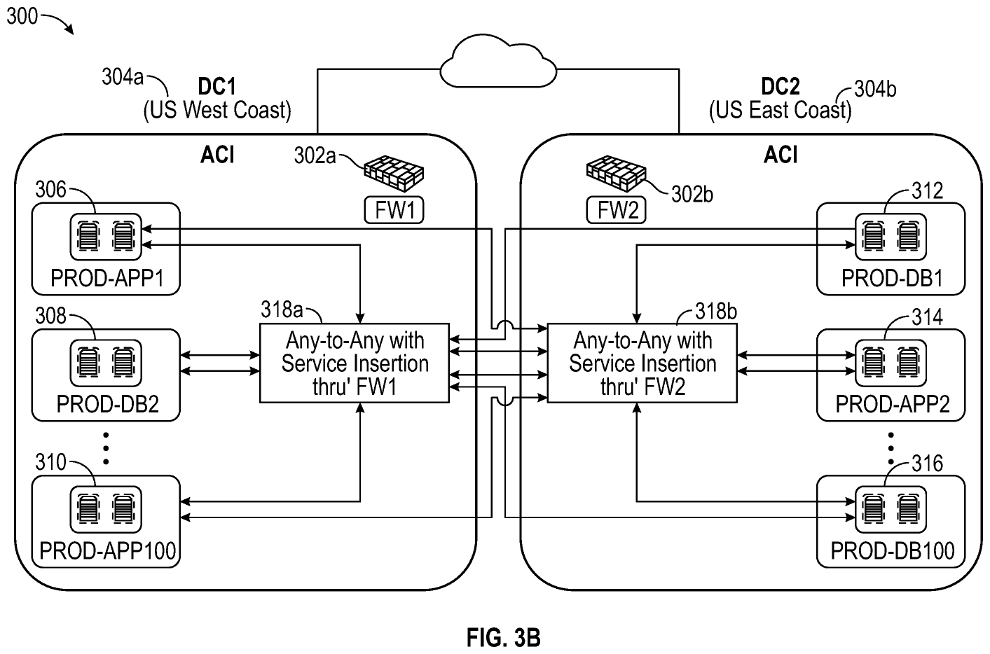

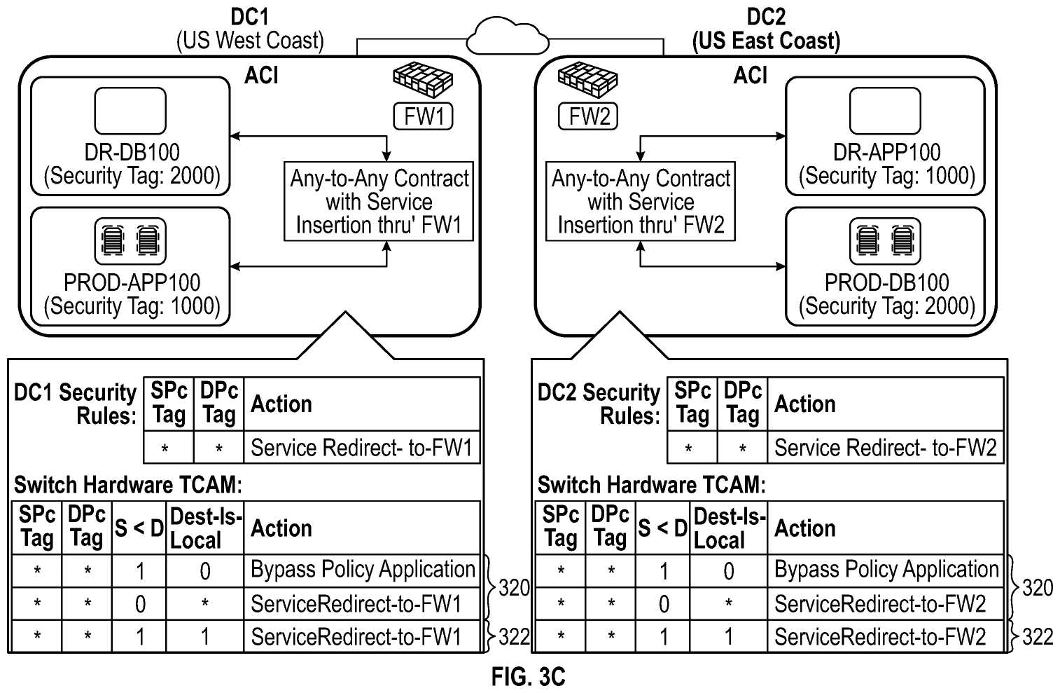

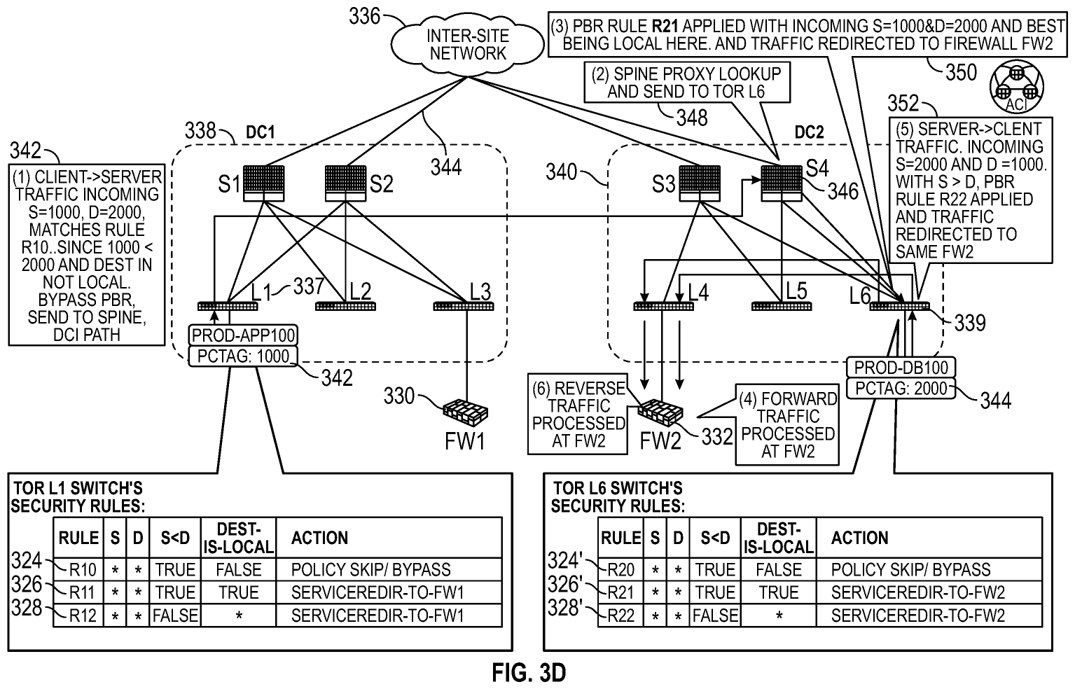

In an example, FIG. 3A shows multiple multi-tier applications each employing decentralized or split computing resources (e.g., split application backend and a database backend) deployed at two or more sites. In the example shown in FIG. 3A, the first site 304a includes a data center (shown as “DC1” 304a) located in the West Coast of the United States, and the second site 304b includes a data center (shown as “DC2” 304b) located in the East Coast of the United States. These backend operations are shown as “PROD-APP1” 306 and “PROD-DB1” 312 in which the application backend “PROD-APP1” 306 is deployed in “DC1” 304a, and the database backend “PROD-DB1” 316 is deployed in “DC2” 304b. A second backend application includes PROD-APP2” 314 and “PROD-DB2” 308 in which the application backend “PROD-APP2” 314 is deployed in “DC2” 304b, and the database backend “PROD-DB2” 308 is deployed in “DC1” 304a.

An ACI enterprise solution may include 100s or 1000s of such backend operations (shown as “PROD-APP100” 310) and “PROD-DB100” 316) that can be split among multiple data centers. Manual configurations, e.g., by network operators or administrators, to link individual inserted network services by a contract or policy can be difficult and cumbersome to manage at such a scale.

For example, in FIG. 3A, a policy or contract may require a firewall inspection operation to be implemented at two corresponding sites in which a first firewall “FW1” 302a is hosted in “DC1” 304a and a second firewall “FW2” 302b is hosted in “DC2” 304b. To achieve symmetricity for bi-directional traffic through the same firewall, namely through “FW1” 302a and “FW2” 302b for the respective direction, a multi-site operator (MSO) may use one of the tiers, say, the database backend “DB1” 312 to pivot and select a firewall corresponding to a database tier's local site. That is, between the application backend “PROD-APP1” 306 and database backend “PROD-DB1” 312, the bi-directional traffic 307 may be manually wired to always get inspected at the firewall “FW2” 302b since the firewall “FW2” 302b is co-located with the database backend “PROD-DB1” 312 in the datacenter “DC2” 304b. Similarly, between the application backend “PROD-APP2” 314 and the database backend “PROD-DB2” 308, the bi-directional traffic 309 may be manually wired to always get inspected at the firewall “FW1” 302a since the firewall “FW1” 302a is co-located with the database backend “PROD-DB2” 308 in the datacenter “DC1” 304a. In addition to configuring the network for symmetric bi-directional traffic, the network administrator may additionally segregate the contracts or policies based on application, e.g., to ensure load balance between the two firewalls “FW1” 302a and “FW2” 302b. It can be observed in FIG. 3A, with applications increasing to the number of policies or contracts to an order of 100s to 1000s, or even more, or increasing in the number of sites from 10s to 100s, a network administrator cannot rely on static configuration-based deployment strategies to scale. The exemplary hardware-assisted operation, e.g., for macro-segment-based distributed service insertion in multi-site data center network devices, may be employed in this example.

In another example, for ACI operations, a single any-to-any contract (or Macro-Segment) having service insertion with flexible application port selection may be configured, e.g., to filter traffic redirected to the inserted services. The inserted services may be spread across the different data centers or remote sites, e.g., to provide for improved scalability, availability, locality, or a combination thereof.

FIG. 3B shows a network 300b configured with a single any-to-any contract 318 (shown as 318a, 318b) for one or more multiple multi-tier applications each employing decentralized or split computing resources (e.g., split application backend and a database backend) deployed at two or more sites. FIG. 3B can be viewed as an equivalent of FIG. 3A. The diagram shows an example 1-to-1 (also referred to as “1:1”) contract with a service insertion. As shown in FIG. 3B, the traffic may be routed through the single any-to-any contract 318 for each given site.

FIG. 3C shows an example configuration of local network devices, e.g., the ASIC or circuit-assisted operator logic of the network device (in combination with the inter-site controller and intra-site controller (e.g., multi-site or site controller) to provide symmetric bi-directional services for the network of FIG. 3B. The ASIC or circuit-assisted operator logic of the network device is configured to perform an ASIC pipeline operation, e.g., via a TCAM lookup operation, to look up or determine applicable rules for a given packet based on an arithmetic or bitwise operation. The rules can direct the routing circuit to either route the packet to an applicable inserted service or to bypass or not redirect the packet per the policy or contract.

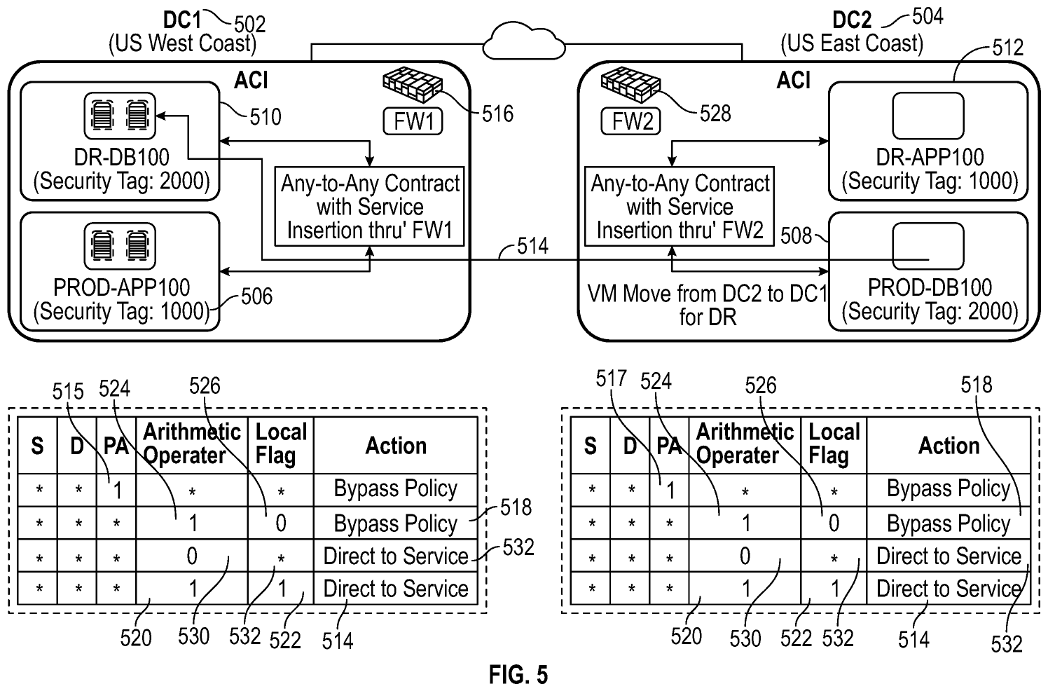

In the example shown in FIG. 3C, the rules include a first rule (320) based on the arithmetic or bitwise operator to direct the packet to the inserted network service or to bypass the operation. The rules may also include a second rule 322 to direct the hardware to direct the packet to the inserted network service if the packet or traffic destination is local. This second rule 322 ensures that there is no security hole associated with routing using the first rule 320. In some embodiments, a third rule (not shown—see FIG. 5) (i.e., applied-once or applied-already rule) may be applied that bypasses the first and second rules to invoke the policy or contract has already been applied.

The ASIC or circuit-assisted operator logic and associated arithmetic or bitwise operation provide a unique data path to deterministically select an inserted network service for multiple directions of traffic flow. The implementation is straightforward and without great complexity, making its deployment also straightforward for network operators and administrators. The exemplary hardware-assisted operation may be implemented for any multi-site data center or enterprise fabric which may employ SG-ACL for a policy or contract (e.g., security) and service insertion, e.g., to improve scalability via automation.

While role- or SG-based ACL as used for macro-segment-based distributed service insertion may result in a scenario having a tie between the selection of inserted services, the ASIC or circuit-assisted operator logic, and associated arithmetic or bitwise operation may be employed in such configurations to tie break such selection in a deterministic manner. That is, the exemplary system may be applied to any fabric, e.g., where SG-ACLs or role-based ACLs are employed to convey the policy intent in a flexible, automatable way and at scale in which, in these fabrics, ingress or egress network devices (e.g., ingress or egress ACL devices) are typically or previously applied at each interface in a non-scalable manner. Tie-breaking may be technically challenging, e.g., in the macro-segment- (or VRF-) based direct or redirect because the routing decisions that may govern the inter-site forwarding may be independent of the policy operations, and the bi-directional flow should pick exactly one firewall in the path.

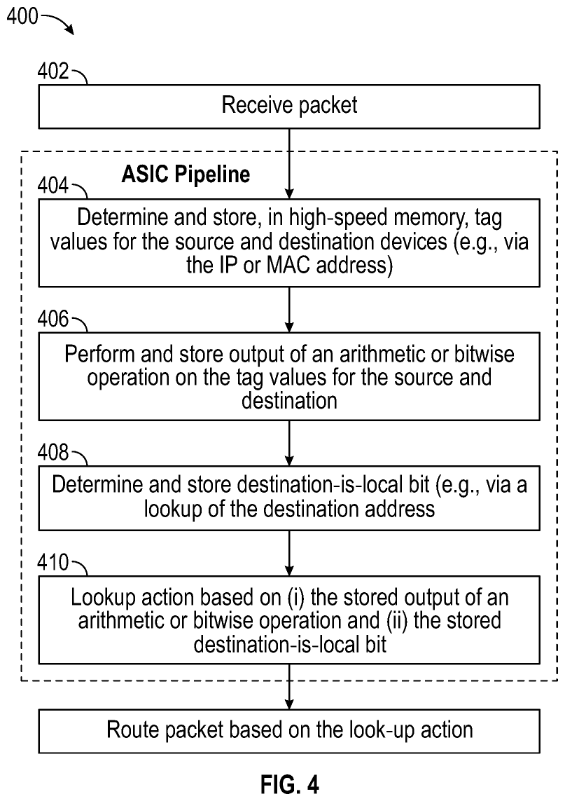

FIG. 4 shows the ASIC or logic-assisted operation executed in an ASIC pipeline 401. In the example shown in FIG. 4, pipeline 401 may determine (404) and store, in high-speed memory, tag values for the source and destination devices (e.g., via the IP or MAC address). In some embodiments, the tag values for the source and destination device may be determined as a mask (e.g., 12-bit mask, etc.) of a 48-bit or 64-bit MAC address or 32-bit or 128-bit IP address for the source and destination devices. For example, pipeline 401 may determine a source and destination pctags (shown as “S” and “D” in FIG. 3D) based on the IP or MAC address of forward direction traffic received (402) at a network device. The tag values (e.g., source and destination pctags) may be stored (404) in high-speed memory (shown as TCAMs). The data plane may then perform (406) an arithmetic or bitwise operation on the tag values for the source and destination. The output of the arithmetic or bitwise operation is stored (406) in high-speed memory. The data plane also evaluates the destination address of the forward direction traffic to determine (406) if the destination is a local network device. The data plane (e.g., switch ASIC) stores (408) the destination is local indicator dest-is-local in the high-speed memory, e.g., TCAMs. The ASIC pipeline then retrieves (410), via a TCAM lookup operation, the routing rules, e.g., to an inserted network service based on arithmetic operator and the destination is local indicator dest-is-local.

Random-access memory (RAM) generally operates by returning the content of memory cells at a specified address. Content addressable memory (CAM) returns the address or location for a content of interest, e.g., a binary key. While binary CAM can match only on the binary zeroes and ones, tertiary content address memory (TCAM) employs a mask that can also match a third state: any value or the don't care. Here, the TCAM lookup operation facilitates a lookup of two operations for a given policy or contract, namely, route the packet to the defined inserted network service (shown as “R11” 326, “R21” 326′, “R12” 328, and “R22” 328′) or bypass/ignore this routing operation (shown as “R10” 324 and “R20” 324′).

Forward direction Traffic Handling: FIG. 3D shows an example operation of the ASIC or logic-assisted circuit of switch “L1” (337) in the data center “DC1” (338) and the ASIC or logic-assisted circuit of switch “L6” (339) in the data center “DC2” (340). Upon a packet being received at the switch “L1” (337), the ASIC or logic-assisted circuit of switch “L1” (337) determines the source and destination pctags (shown as “S” and “D”) having a source value S=1000 and a destination value D=2000, e.g., derived or determined based on an identifier of the source or destination device (e.g., IP or MAC address of the source or destination devices). The ASIC or logic-assisted circuit of switch “L1” performs an arithmetic or bitwise operation on the tag values for the source and destination (shown as “S<D”) (which is TRUE) and evaluates the destination address of the forward direction traffic to determine if the destination is a local network device (which is FALSE) of the first data center “DC1” 338. The values of the source tag, the destination tag, the output of the arithmetic or bitwise operation, and the destination-is-local flag are used, via a TCAM lookup operation, to match (342) to rule “R10” 324 that skip or bypass the policy. The data plane of switch “L1” (337) thus sends (344) the packet from the first data center “DC1” 338 to a spline node “S4” 346 of the second data center “DC2” 340. The spline node “S4” 346 performs a proxy lookup and sends (348) the packet to the destination device, namely, the leaf node “L6” 339. The values of the source tag, the destination tag, the output of the arithmetic or bitwise operation (which is still TRUE), and the destination-is-local flag (which is now TRUE) are used, via a TCAM lookup operation, at the leaf node “L6” 339, to match (350) to rule “R21” 326′ that directs the data plane of leaf node “L6” 339 to forward the packet to the inserted network service “FW2” 332, e.g., as a next-hop prior to the packet being received at a network device having the local destination address.

Reverse direction Traffic Handling: For the return traffic, FIG. 3D shows a packet being received at the leaf node “L6” (339); the ASIC or logic-assisted circuit of leaf node “L6” (339) determines the source and destination pctags (“S=2000” and “D=1000”), e.g., derived or determined based on an identifier of the source or destination device (e.g., IP or MAC address of the source or destination devices). The ASIC or logic-assisted circuit of switch “L6” (339) then performs an arithmetic or bitwise operation on the tag values for the source and destination (shown as “S<D”) and evaluates the destination address of the forward direction traffic to determine if the destination is a local network device of the second data center “DC2” 340. The values of the source tag, the destination tag, the output of the arithmetic or bitwise operation (which is FALSE), and the destination-is-local flag (which is FALSE) are used, via a TCAM lookup operation, to match (342) to rule “R22” 328′ that directs (352) the data plane of leaf node “L6” 339 to forward the packet to the switch “L1” (337) through the inserted network service “FW2” 332. Then, at the switch “L1” (337), because the inserted service has already been applied at the second data center “DC2” 340, the switch “L1” (337) bypass the evaluation for additional inserted service operations.

### Example Multi-Site Disaster Recovery (DR)

FIG. 5 shows another example of the operation of the ASIC or logic-assisted operation for multi-site disaster recovery (DR) operation.

In the example of FIG. 5, a multi-tier disaster recovery (DR) application is implemented via decentralized or split computing resources deployed at two or more sites, including at a first site 502 (shown as “DC1” 502) and a second site 504 (shown as “DC2” 504). In the example, the first site 502 is located in the West Coast of the United States, and the second site 504 is located in the East Coast of the United States. A split operation is shown comprising a production application 506 (shown as “Prod-App100” 506) executing at the first site 502, and an associated database application 508 (shown as “Prod-DB100” 508) executing at the second site 504. The first site 502 also executes a disaster recovery system 510 (shown as “DR-DB100” 510) for the database application 508, and the second site 504 also executes a disaster recovery system 512 (shown as “DR-APP100” 512) for the database application 506. Indeed, each site provides disaster-recovery infrastructure for the other site.

In the example of a disaster recovery operation is initiated or occurred (514) at database application “Prod-DB100” 508 executing at the second site 504, and an IP address move is forwarded to the disaster recovery system “DR-DB100” 510. In some embodiments, the IP address of the database application “Prod-DB100” 508 is moved, e.g., via a VMotion operation, to the disaster recovery system “DR-DB100” 510. That is, the virtual machines (VMs) in the EndPoint Groups (EPG) of the database application “Prod-DB100” 508 is now moved (e.g., via VMotion) to the disaster recovery system “DR-DB100” 510 of the first site 502.

Because the IP address of the database application “Prod-DB100” 508 is moved to the disaster recovery system “DR-DB100” 510, the ASIC or logic-assisted operation would generate the same source and destination pctags for the disaster recovery system “DR-DB100” 510. Thus, the same arithmetic or bitwise operator (e.g., S<D) to determine the routing to an inserted network service for a given policy or contract would be the same for the disaster recovery system “DR-DB100” 510.

Post-Migration—forward direction. As an example, a packet is sent from the production application “Prod-App100” 506 of the first site 502 to the database application, now, the disaster recovery system “DR-DB100” 510, also of the first site 502. The ASIC or logic-assisted circuit of a first node within the production application “Prod-App100” 506 determines the source and destination pctags (“S=1000” and “D=2000”), e.g., derived or determined based on an identifier of the source or destination device (e.g., IP address of the source or destination devices). The ASIC or logic-assisted circuit of the first node within the production application “Prod-App100” 506 then performs an arithmetic operation on the tag values for the source and destination (shown as “S<D,” which is TRUE) and evaluates the destination address of the forward direction traffic to determine if the destination to a destination node linked to a second node of the disaster recovery system “DR-DB100” 510 is a local network device of the first site 502 (which is TRUE). The values of the source tag, the destination tag, the output of the arithmetic operation (520), and the destination-is-local flag (522) are used, via a TCAM lookup operation, to match to rule 514 that directs the data plane of the first node within the production application “Prod-App100” 506 to forward the packet to the second node of the disaster recovery system “DR-DB100” 510 through the inserted network service “FW1” 516 (e.g., to the inserted network service “FW1” 516 at the next hop with a destination address of a computing resource located at the second node of the disaster recovery system “DR-DB100” 510).

The packet is received at the second node of the disaster recovery system “DR-DB100” 510 at local site 502 from the production application “Prod-App100” 506 of the first site 502. The ASIC or logic-assisted circuit of a second node within the disaster recovery system “DR-DB100” 510 determines an inserted service has already been applied at the local site 502 (e.g., based on previously-applied “PA” flag 515) and bypasses the evaluation for additional inserted service operations.

Same Post-Migration—Reverse direction. For the reverse traffic direction, a second packet is sent from the database application, now, disaster recovery system “DR-DB100” 510 of the first site 502 to the production application “Prod-App100” 506 also of the first site 502. The ASIC or logic-assisted circuit of a second node within the disaster recovery system “DR-DB100” 510 determines the source and destination pctags (“S=2000” and “D=1000”), e.g., derived or determined based on an identifier of the source or destination device (e.g., IP address of the source or destination devices). The ASIC or logic-assisted circuit of the second node within the disaster recovery system “DR-DB100” 510 then performs an arithmetic operation on the tag values for the source and destination (shown as “S<D,” which is FALSE) and evaluates the destination address of the forward direction traffic to determine if the destination is a local network device of the first site 502 (which is TRUE). The values of the source tag, the destination tag, the output of the arithmetic operation (520), and the destination-is-local flag (522) are used, via a TCAM lookup operation, to match to rule 514 that directs the data plane of the second node within the disaster recovery system “DR-DB100” 510 to forward the second packet to a third node of the production application “Prod-App100” 506 through the inserted network service “FW1” 516 (e.g., to the inserted network service “FW1” 516 at a next hop with a destination address of a computing resource located at the third node of the production application “Prod-App100” 506).

Upon receipt of the packet at the production application “Prod-App100” 506 of the first site 502, the ASIC or logic-assisted circuit of a first node within the production application “Prod-App100” 506 determines an inserted service has already been applied (e.g., via flag 515) at the local site 502 and bypasses the evaluation for additional inserted service operations.

Pre-Migration—forward direction. Still in this example, prior to disaster recovery migration, a packet is sent from the production application “Prod-App100” 506 of the first site 502 to the database application of the database application “PROD-DB100” 508 of the second site 504. This has a similar network configuration as shown in FIG. 3D. Thus, the ASIC or logic-assisted circuit of a first node within the production application “Prod-App100” 506 determines the source and destination pctags (“S=1000” and “D=2000”), e.g., derived or determined based on an identifier of the source or destination device (e.g., IP address of the source or destination devices). The ASIC or logic-assisted circuit of the first node within the production application “Prod-App100” 506 then performs an arithmetic operation on the tag values for the source and destination (shown as “S<D,” which is TRUE) and evaluates the destination address of the forward direction traffic to determine if the destination to a second node of the disaster recovery system “DR-DB100” 510 is a local network device (which is FALSE). The values of the source tag, the destination tag, the output of the arithmetic operation (524), and the destination-is-local flag (526) are used, via a TCAM lookup operation, to match to rule 518 that bypass the re-routing operation (e.g., to a local inserted network service) and thus maintains the routing of the packet to the database application “PROD-DB100” 508. The packet is then forwarded to the database application “PROD-DB100” 508.

The packet is received at the second node of the database application “PROD-DB100” 508 at local site 504 from the production application “Prod-App100” 506 of the first site 502. The ASIC or logic-assisted circuit of the second node within the database application “PROD-DB100” 508 determines the source and destination pctags (“S=1000” and “D=2000”), e.g., derived or determined based on an identifier of the source or destination device (e.g., IP address of the source or destination devices). The ASIC or logic-assisted circuit of the second node within the database application “PROD-DB100” 508 then performs an arithmetic operation on the tag values for the source and destination (shown as “S<D,” which is TRUE) and evaluates the destination address of the forward direction traffic to determine if the destination to a destination node linked to the second node of the database application “PROD-DB100” 508 is a local network device of the second site 504 (which is TRUE). The values of the source tag, the destination tag, the output of the arithmetic operation (520), and the destination-is-local flag (522) are used, via a TCAM lookup operation, to match to rule 514 that directs the data plane of the second node of the database application “PROD-DB100” 508 to the inserted network service “FW1” 516 (e.g., to the inserted network service “FW2” 528 at a next hop with a destination address of a computing resource located at the second node of the database application “PROD-DB100” 508).

Same Pre-Migration—reverse direction. For the reverse traffic direction, a second packet is sent from the database application “PROD-DB100” 508 of the second site 504 back to the production application “Prod-App100” 506 of the first site 502. The ASIC or logic-assisted circuit of a second node within the database application “PROD-DB100” 508 determines the source and destination pctags (“S=2000” and “D=1000”), e.g., derived or determined based on an identifier of the source or destination device (e.g., IP address of the source or destination devices). The ASIC or logic-assisted circuit of the second node within the database application “PROD-DB100” 508 then performs an arithmetic operation on the tag values for the source and destination (shown as “S<D,” which is FALSE) and evaluates the destination address of the forward direction traffic to determine if the destination is a local network device (which is FALSE). The values of the source tag, the destination tag, the output of the arithmetic operation (530), and the destination-is-local flag (532) are used, via a TCAM lookup operation, to match to rule 532 that directs the data plane of the second node within the database application “PROD-DB100” 508 to forward the second packet to the production application “Prod-App100” 506 through the inserted network service “FW2” 528 executing at the second site 504.

Upon receipt of the packet at the production application “Prod-App100” 506 of the first site 502, the ASIC or logic-assisted circuit of a first node within the production application “Prod-App100” 506 determines an inserted service has already been applied (e.g., via flag 515) at the local site 502 and bypasses the evaluation for additional inserted service operations.

Similar modeling of traffic flow may be applied to other inter-site network operations.

It should be understood that the various techniques and modules described herein, including the control-plane-data-plane interface transport module, may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Embodiments of the network device may be implemented, in whole or in part, in virtualized network hardware in addition to physical hardware.

Although exemplary implementations may refer to utilizing aspects of the presently disclosed subject matter in the context of one or more stand-alone computer systems, the subject matter is not so limited but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents.

What is claimed is:

1. A network device comprising:
a high-speed memory; and
a logic circuitry operatively coupled to the high-speed memory, the logic circuitry being configured, via a pipeline operation comprising arithmetic or bitwise operator, to route bi-directional traffic symmetrically through inserted services among two or more network sites or infrastructure, including a first network site or infrastructure and a second network site or infrastructure by:
receiving, via the logic circuitry, a packet of the bi-directional traffic for an application executing between computing resources located at the first network site or infrastructure and the second network site or infrastructure;
determining, via the arithmetic or bitwise operator, an output value derived from a routing data located within the packet; and
routing the packet to at least one of a set of one or more insertable network services in accordance with a policy or contract based at least in part on the output value of the arithmetic or bitwise operator.

2. The network device of claim 1, wherein the packet is received at a second network device of the second network site or infrastructure, the second network device being configured to (i) receive the packet via logic circuitries of the second network device, (ii) determine via an arithmetic or bitwise operator of the second network device an output value derived from the routing data located within the packet, and (iii) route the packet to at least one of a set of one or more insertable network services of the second network site or infrastructure in accordance with the policy or contract based at least in part on the output value of the arithmetic or bitwise operator of the second network device.

3. The network device of claim 1, wherein the routing of the packet to at least one of a set of one or more insertable network services in accordance with the policy or contract employs (i) the output value of the arithmetic or bitwise operator and (ii) a flag or identifier associated with the destination address being a local network device of a network associated with the network device.

4. The network device of claim 1, wherein the arithmetic or bitwise operator comprises an arithmetic comparator.

5. The network device of claim 1, wherein the arithmetic or bitwise operator comprises an XOR bitwise comparator.

6. The network device of claim 1, wherein the set of one or more insertable network services include at least one of a deep packet inspection (DPI) service, a load balancing (LB) service, an intrusion prevention system (IPS) service, a malware protection service, and a firewall inspection service.

7. The network device of claim 1, wherein the policy or contract includes at least one of a security policy, a performance policy, a quality-of-service (QOS) policy, a disaster recovery policy, and a visibility policy.

8. The network device of claim 1, wherein the high-speed memory maintains a logic table that selects, via a single lookup action of high-speed memory, a network action to route the packet to the set of one or more insertable network services in accordance with the policy or contract or to bypass the network action.

9. The network device of claim 1, wherein the high-speed memory comprises tertiary content addressable memory (TCAM) or content addressable memory (CAM).

10. The network device of claim 8, wherein the logic table includes a first rule to select the network action to route the packet to the set of one or more insertable network services in accordance with the policy or contract based on a first value for the arithmetic or bitwise operator and a masked value for a flag or identifier associated with the destination address being a local network device of a network associated with the network device.

11. The network device of claim 8, wherein the logic table includes a second rule to select the network action to route the packet to the set of one or more insertable network services in accordance with the policy or contract based on a first value for the arithmetic or bitwise operator and a second value for a flag or identifier associated with the destination address being a local network device of a network associated with the network device.

12. The network device of claim 8, wherein the logic table includes a third rule to bypass the network action to route the packet to the set of one or more insertable network services in accordance with the policy or contract based on a first value for the arithmetic or bitwise operator and a second value for a flag or identifier associated with the destination address being a local network device of a network associated with the network device.

13. The network device of claim 8, wherein the policy or contract is defined at an inter-site controller or an intra-site controller, the policy or contract being provided from the inter-site controller or the intra-site controller to configure the logic table.

14. The network device of claim 1, comprising:
a processor; and
a memory having instructions stored thereon, wherein execution of the instructions by the processor causes the processor to (i) receive the policy or contract (e.g., from the inter-site controller or the intra-site controller) and (ii) store a routing action of the policy or contract to the high-speed memory.

15. The network device of claim 2, wherein the packet is a multicast packet and is received at the second network device of the second network site or infrastructure and a third network device of the second network site or infrastructure.

16. The network device of claim 2, wherein the packet is a multicast packet and is received at the second network device of the second network site or infrastructure and a third network device of a third network site or infrastructure.

17. A system comprising:
a processor; and
a memory having instructions stored thereon, wherein execution of the instructions by the processor causes the processor to:
receive a policy or contract for a set of one or more insertable network services to execute between two or more network sites or infrastructure, including a first network site or infrastructure and a second network site or infrastructure;
transmit the policy or contract to one or more first network devices of the first network site or infrastructure, including a first network device, and one or more second network devices of the second network site or infrastructure, including a second network device, wherein the first network device and the second network device are configured to symmetrically route bi-directional traffic among each other,
wherein the first network device includes a high-speed memory and a logic circuitry operatively coupled to the high-speed memory, the logic circuitry being configured, via a pipeline operation comprising arithmetic or bitwise operator, to symmetrically route bi-directional traffic with the second network device.

18. The system of claim 17, wherein the bi-directional traffic is received at a second network device of the second network site or infrastructure, the second network device being configured to (i) receive a packet of the bi-directional traffic via logic circuitries of the second network device, (ii) determine via an arithmetic or bitwise operator of the second network device an output value derived from the routing data located within the packet, and (iii) route the packet to at least one of a set of one or more insertable network services of the second network site or infrastructure in accordance with the policy or contract based at least in part on the output value of the arithmetic or bitwise operator of the second network device.

19. The system of claim 17, wherein the first network device is configured to route a packet to at least one of a set of one or more insertable network services in accordance with the policy or contract using (i) an output value determined from the arithmetic or bitwise operator and (ii) a flag or identifier associated with the destination address being a local network device of a network associated with the first network device.

20. The network device of claim 1, wherein the arithmetic or bitwise operator comprises an arithmetic comparator or an XOR bitwise comparator.
